(19) United States
(12) Patent Application Publication
(10) Pub. No.: US 2009/0211397 A1
(43) Pub. Date: Aug. 27, 2009

(54) Flexible Motor Coupling Device

(75) Inventors: David G. O'Connor, North Bend, WA (US); Robert B. Nelson, Snoqualmie, WA (US)

Correspondence Address: ASEMBLON, INC;JEFFREY B. OSTER -- LEGAL DEPARTMENT, 15340 NE 92ND ST, SUITE B, REDMOND, WA, 98052, US

(73) Assignee: Asemblon, Inc.

(21) Appl. No.: 12/372,411

(22) Filed: Feb. 17, 2009

Related U.S. Application Data
(60) Provisional application No. 61/031,201, filed on Feb. 25, 2008.

(51) Int. Cl. F16H 33/20

(52) U.S. Cl. 74/84 R

(57) ABSTRACT

There is disclosed a flexible motor coupling device that provides for distance changes along a lateral axis between a motor shaft and a device to be actuated (such as a valve shaft). More specially, there is disclosed a motor coupling device comprising an outer casing having an axis therein and a carriage shaft, wherein the carriage shaft moves laterally along the axis of rotation and is surrounded by ball bearings.

### CROSS-REFERENCE TO RELATED APPLICATION

This patent application claims priority to U.S. provisional patent application 61/031,201 filed on 25 Feb. 2008.

### TECHNICAL FIELD

The present disclosure provides a flexible motor coupling device that provides for distance changes along a lateral axis between a motor shaft and a device to be actuated (such as a valve shaft). More specially, the present disclosure provides a motor coupling device comprising an outer casing having an axis therein and a carriage shaft, wherein the carriage shaft moves laterally along the axis of rotation and is surrounded by ball bearings.

### BACKGROUND

Conventional mechanical and electromechanical systems providing linear motion for positioning structural components typically employ actuator mechanisms which require that the moving, or translated component always approach a desired or target position from the same direction. Such a unidirectional approach attempt to optimize accuracy by minimizing positional errors contributed or exacerbated by rotational backlash in the drive mechanism. The term “backlash” generally refers to inaccuracies (such as play or looseness) in the connection between a drive component which require that a motor shaft, coupling mechanism, or both must rotate through some initial displacement before any motion is coupled to a translated component, such as a valve.

The known unidirectional approach to alleviating backlash often requires the target position from the “correct” or selected direction. In addition, such translational systems are often characterized by slow response times and inaccurate control loops.

Typically, an electric motor drives the translated component through a crankshaft which is rotatably secured to the translated component.

### SUMMARY

The present disclosure provides a flexible motor coupling device comprising:

(a) an outer casing having an axis therein and two sides; and

(b) a carriage shaft, wherein the carriage shaft moves laterally along the axis of rotation and is surrounded by ball bearings.

Preferably, the outer casing having two sides has a first side facing a motor and a second side facing a device to be actuated. More preferably, the device to be actuated is a valve that functions by opening or closing a valve upon rotational movement of the carriage shaft. Preferably, the lateral movement of the carriage occurs for just one side of the outer casing. Most preferably, the side of the outer casing that has lateral movement is the second side.

Preferably, the outer casing has a series of helical cuts whereby the outer casing can flex for off center of rotation of shafts. Preferably, the ball bearings are held in place by a plurality of rigid sheets of ball bearing spacers. Preferably, the carriage shaft further comprises two v-grooves that hold the ball bearings.

### BRIEF DESCRIPTION OF THE FIGURES

FIG. 1 shows a schematic of the disclosed flexible motor coupling device, specifically a cut-away of the coupling casing.

FIG. 2 shows a close up side view of the coupler casing showing a series of helical cuts (8 in FIG. 1) which flex for off center rotation of shafts. In particular in FIG. 2A, the depth of the helical cuts are shown in the flattened depiction of the outer coupler casing. FIG. 2B shows the coupler casing in a cylindrical shape without showing any flexing for any off-center rotation.

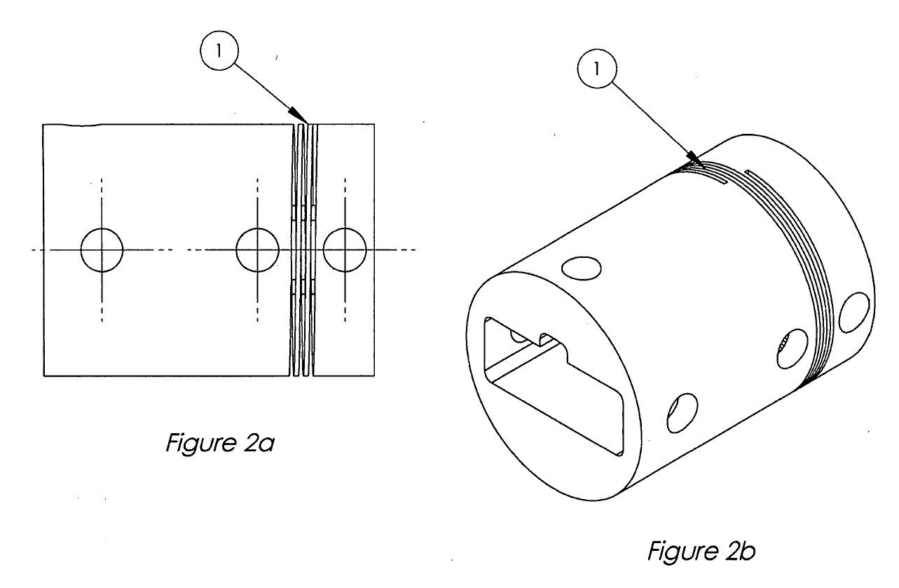

### DETAILED DESCRIPTION

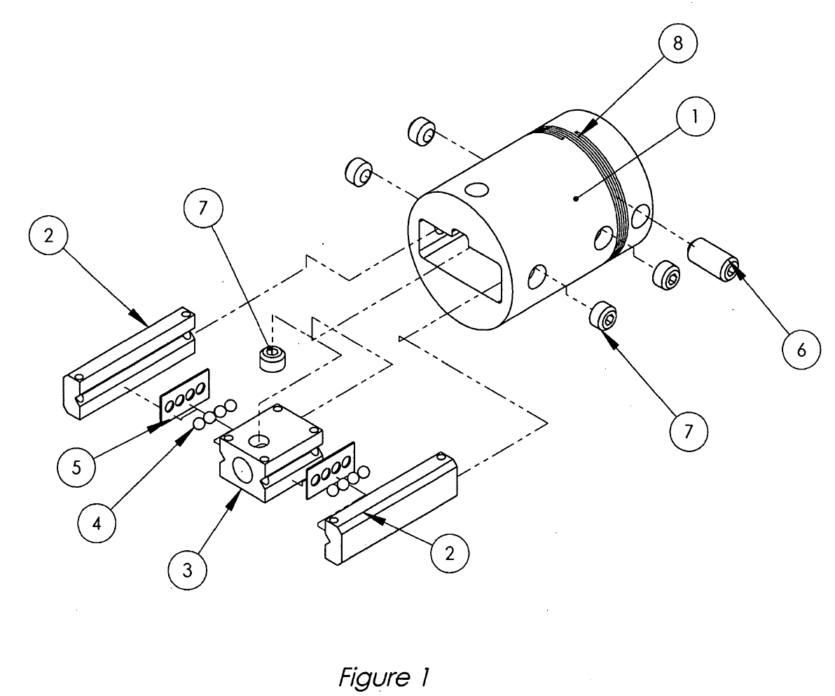

The present disclosure provides a flexible motor coupling device. Specifically, and with regard to FIG. 1, a coupler casing (1) houses all of the components that make up the disclosed flexible motor coupling device. The coupler casing 1 is also attached to a motor shaft (not shown) and secured by a set screw 6. There are two stationary “v groove” slides 2 that fit within an opening of the coupler casing 1. The v groove slides 2 provide support to a plurality of ball bearings 4. The v grooves 2 match up with of a carriage device 3, also having v grooves on each of its two sides, and provides a track the carriage 3 will follow as it translates. Moreover, the ball bearings 4 couple rotational output from the motor shaft (not shown) to the carriage. The ball bearings 4 also provide a translation means. The ball bearings 4 are held in place by ball bearing spacers 5 comprising rigid sheets having holes within to align the ball bearings so during translation the ball bearings do not come into contact with each other. Further, the groove slides 2 attach to a valve shaft (not shown in FIG. 1) that is located within the circular opening within the carriage 3.

In addition, a set screw 6 attaches the coupler to the drive shaft. A set screw 7 attaches the carriage with v grooves 3 to the valve shaft.

The coupler casing shows a series of helical cuts (8 in FIG. 1) which flex for off center rotation of shafts.

We claim:

1. A flexible motor coupling device comprising:
(a) an outer casing having an axis therein and two sides; and
(b) a carriage shaft, wherein the carriage shaft moves laterally along the axis of rotation and is surrounded by ball bearings.

2. The flexible motor coupling device of claim 1 wherein the outer casing having two sides has a first side facing a motor and a second side facing a device to be actuated.

3. The flexible motor coupling device of claim 2 wherein the device to be actuated is a valve that functions by opening or closing a valve upon rotational movement of the carriage shaft.

4. The flexible motor coupling device of claim 1 wherein the lateral movement of the carriage occurs for just one side of the outer casing.

5. The flexible motor coupling device of claim 4 wherein the side of the outer casing that has lateral movement is the second side.

6. The flexible motor coupling device of claim 1 wherein the outer casing has a series of helical cuts whereby the outer casing can flex for off center of rotation of shafts.

7. The flexible motor coupling device of claim 1 wherein the ball bearings are held in place by a plurality of rigid sheets of ball bearing spacers.

8. The flexible motor coupling device of claim 1 wherein the carriage shaft further comprises two v-grooves that hold the ball bearings.
